(19) United States
(12) Patent Application Publication
(10) Pub. No.: US 2012/0154721 A1
(43) Pub. Date: Jun. 21, 2012

(54) OPTICAL FILTER AND LIQUID CRYSTAL DISPLAY INCLUDING THE SAME

(76) Inventors: Seong Heun CHO, Uiwang-si (KR); Kyoung Ku Kang, Uiwang-si (KR); Young Cheol Lee, Uiwang-si (KR)

(21) Appl. No.: 13/271,430

(22) Filed: Oct. 12, 2011

(30) Foreign Application Priority Data
Dec. 17, 2010 (KR) 10-2010-0130089

(51) Int. Cl. G02F 1/1335; G02B 5/30; G02B 1/11

(52) U.S. Cl. 349/104; 359/614; 359/488.01

(57) ABSTRACT

An optical filter includes a non-crystalline film, a protective coating layer on one side of the non-crystalline film, and a print layer on another side of the non-crystalline film, the other side being opposite to the one side, wherein the print layer is secured to a substrate.

### BACKGROUND

1. Field

Embodiments relate to an optical filter and liquid crystal display (LCD) including the same.

2. Description of the Related Art

A glass substrate, a base film, and functional coating layers, such as a hard coating, an antireflective coating, and the like, may be stacked on a front side of a polarizer film constituting a screen part of a liquid crystal display (LCD).

### SUMMARY

One or more embodiments may provide an optical filter including a non-crystalline film, a protective coating layer on one side of the non-crystalline film, and a print layer formed on another side of the non-crystalline film, the other side being opposite to the one side, wherein the print layer is secured to a substrate.

The non-crystalline film may be a transparent non-oriented film.

The non-crystalline film may include a cellulose resin, a polycarbonate resin, a (meth)acrylate resin, a cycloolefin resin, an amorphous polyester resin, or combinations thereof.

The protective coating layer may include an antireflective coating, a hard coating, or a combination thereof.

The optical filter may include a substrate, an adhesive layer, the print layer, the non-crystalline film, the hard coating, and the antireflective coating, stacked in that order.

The print layer may be continuous or discontinuous. The optical filter may further include an adhesive between the print layer and the substrate, the adhesive securing the print layer to the substrate.

The substrate may be a glass substrate or a non-oriented plastic substrate. The non-oriented plastic substrate may be a polymer sheet including glass fibers or a non-oriented cast polycarbonate resin. The optical filter may be on a polarizer film.

A liquid crystal display may include the optical filter according to an embodiment.

### BRIEF DESCRIPTION OF THE DRAWINGS

The embodiments will become apparent to those of ordinary skill in the art by describing in detail exemplary embodiments with reference to the attached drawings, in which:

FIG. 1 illustrates a schematic sectional view of an optical filter according to one embodiment;

FIGS. 2(a) and 2(b) illustrate schematic sectional views of optical filters according to other embodiments;

FIG. 3(a) illustrates a sectional view of an optical filter where only a bezel is printed according to one embodiment;

FIG. 3(b) illustrates a front view of a print layer where only the bezel is printed; and

FIG. 4 illustrates components of a structure of an optical filter of Example 1 and components of a structure of an optical filter of Comparative Example 1.

### DETAILED DESCRIPTION

Korean Patent Application No. 10-2010-0130089, filed on Dec. 17, 2010, in the Korean Intellectual Property Office, and entitled: “Optical Filter and Liquid Crystal Display Including the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “between” two layers, it can be the only layer between the two layers, or one or more intervening layers may also be present. Like reference numerals refer to like elements throughout.

Furthermore, terms used herein are defined in consideration of the function of embodiments and can be changed according to the custom or intention of users or operators. Thus, definition of such terms should be determined according to the overall disclosure set forth herein.

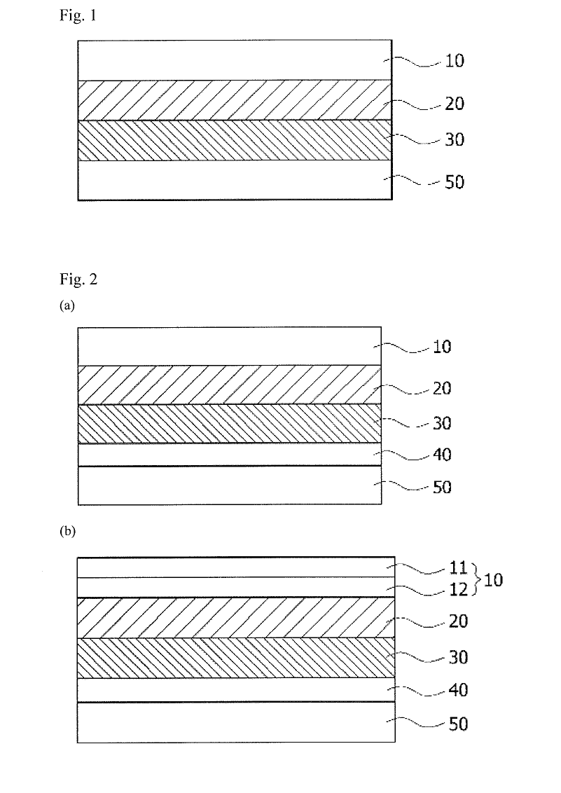

FIG. 1 illustrates a schematic sectional view of an optical filter according to one embodiment. Referring to FIG. 1, the optical filter may include a non-crystalline film 20, a protective coating layer 10 on one side of the non-crystalline film 20, and a print layer 30 formed on another side of the non-crystalline film 20. The print layer 30 may be secured to a substrate 50.

The non-crystalline film 20 may be a transparent non-oriented film and may have an average total light transmittance of about 80% or more, e.g., about 90% or more or about 93% or more, in a visible light range.

The non-crystalline film 20 may include, e.g., cellulose, polycarbonate, (meth)acrylate, cycloolefin, amorphous polyester resins, or combinations thereof. In an implementation, at least two kinds of resins may be blended to form a single film, or two or more layers, e.g., two or more adjacent layers, may be formed of a single resin and may be stacked together.

The non-crystalline film 20 may have a thickness of about 1 to about 200 μm, e.g., about 5 to about 180 μm.

The non-crystalline film 20 may have a crystallinity of about 10% or less, e.g., about 3% or less or about 0.1% or less. When a film having a low crystallinity is used, optical interference by an LCD polarizer film and birefringence may be avoided, thereby reducing or preventing formation of a rainbow pattern.

In an implementation, the non-crystalline film 20 may have a refractive index of about 1.45 to about 1.8. Within this range, a rainbow phenomenon may be reduced or prevented. As such, a clear picture may be realized according to embodiments. For example, the non-crystalline film 20 may have a refractive index of about 1.50 to about 1.75.

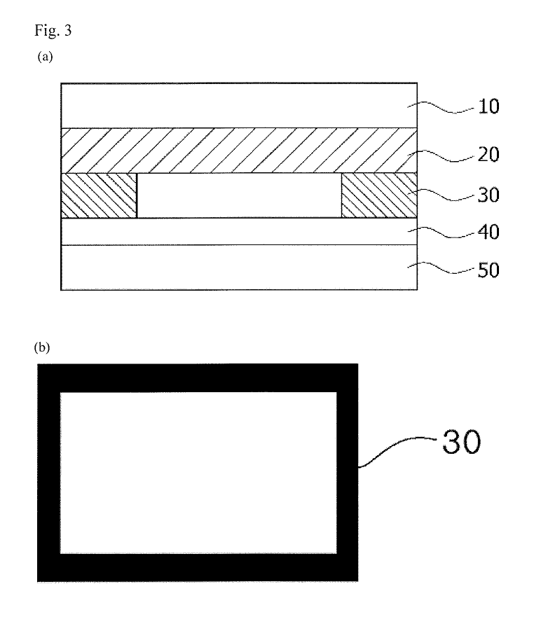

The protective coating layer 10 may be formed on one side of the non-crystalline film 20. FIG. 2(a) illustrates a schematic sectional view of an optical filter according to one embodiment. The protective coating layer 10 may be an antireflective coating, a hard coating, an antistatic coating, or a combination thereof. The protective coating layer 10 may be a single layer. In an implementation, the protective coating layer 10 may be a single layer having multiple functions, e.g., as antireflection, scratch resistance, antistatic properties, and the like.

In another implementation, the protective coating layer 10 may include multiple layers. For example, the protective coating layer 10 may include an antireflective coating layer, a hard coating layer, and an antistatic coating layer, which are separate from one another. Alternatively, the protective coating layer 10 may include a separate antireflective coating layer and a hard coating layer, at least one of which has an antistatic function.

FIG. 2(b) illustrates a schematic sectional view of an optical filter according to another embodiment. As shown in FIG. 2(b), the protective coating layer 10 may include an antireflective coating layer 11 and a hard coating layer 12, wherein the hard coating layer 12 is on the non-crystalline film 20, e.g., directly contacts the non-crystalline film 20. The hard coating layer 12 may prevent the non-crystalline film 20 from being scratched. For example, the hard coating layer 12 may have a pencil hardness of 3H or more.

The hard coating layer 12 may include, e.g., a siloxane resin, an acrylic resin, a melamine resin, an epoxy resin, or combinations thereof. In an implementation, the hard coating layer 12 may include a heat curable or UV curable resin containing dispersed silica particles (that may be obtained by reaction of an alkyl alkoxy silane and colloidal silica in a hydrophilic solvent). The dispersed silica particles may have high hardness to help improve abrasion resistance. In another implementation, the hard coating layer 12 may include a UV curable hard coating material including urethane acrylate and multifunctional acrylate as main ingredients. Heat and radiation curable resins for forming the hard coating layer 12 may include a resin including a compound having at least two functional groups. Examples of the resin may include a compound having an unsaturated double bond, such as (meth)acrylate, and a reactive substituent, such as an epoxy group or silanol group. Further, the hard coating layer 12 may include a fluorine containing epoxy acrylate, a fluorine containing alkoxy silane, or the like.

The antireflective coating layer 11 may prevent glare. The antireflective coating layer 11 may be formed in a single layer or multiple layers.

When the antireflective coating layer 11 is a single layer, it may have a refractive index of about 1.30 to about 1.50.

When the antireflective coating layer 11 is composed of multiple layers, it may include at least two layers having different refractive indices. In an implementation, the antireflective coating layer 11 may include a high refractive layer having a refractive index of about 1.55 to about 2.4 and a low refractive layer having a refractive index of about 1.30 to about 1.50. The high refractive layer may be disposed as a first layer adjacent the non-crystalline film 20 and the low refractive layer may be disposed on the first layer.

The coating layers may be formed by, e.g., spin coating, bar coating, dip coating, roll coating, screen coating, or the like. The print layer 30 may be on the other side of the non-crystalline film 20, e.g., opposing the protective coating layer 10. The print layer 30 may be formed using ink in which black, gray, white, or silver dyes or pigments are dispersed. The color of dyes or pigments may be varied as desired.

The print layer 30 may be formed continuously or discontinuously. For example, printing may be performed by roll coating using a gravure roll processed in a bezel shape or screen printing using a screen patterned in a bezel shape. In an implementation, the print layer 30 may be formed by printing only a bezel, e.g., excluding a screen part, or in various other patterns. FIG. 3(a) illustrates a schematic sectional view of an optical filter in which only a bezel is printed. FIG. 3(b) illustrates a front view of the print layer in which only the bezel is printed. When only the bezel is printed, the configuration of stacked films is not apparent or visible, so that additional frames may not be needed. Accordingly, excellent appearance, decreased product weight, and reduced product price, may be achieved.

The print layer 30 may be secured to the substrate 50. The print layer 30 may be secured to the substrate 50 using pressure-sensitive adhesives or using its own pressure-sensitive adhesion property. FIGS. 2 and 3 illustrate examples wherein a pressure-sensitive adhesive layer 40 may be formed between the print layer 30 and the substrate 50.

The pressure-sensitive adhesive layer 40 may be formed of a transparent pressure-sensitive adhesive or a transparent pressure-sensitive adhesive film, and the transparent pressure-sensitive adhesive or the transparent pressure-sensitive adhesive film may include any suitable adhesive component for optical films known in the art. For example, UV curable adhesives and heat curable adhesives may be used. The kind of adhesive is not particularly limited and may be selected by those skilled in the art.

The substrate 50 may be a glass substrate or a non-oriented plastic substrate. For example, the substrate 50 may be an optical glass filter formed on the polarizer film.

The substrate 50 may have a thickness of about 0.5 to about 10 mm.

In an implementation, the substrate 50 may include not only glass but non-oriented plastics. Examples of the non-oriented plastics may include a polymer sheet including glass fiber, a non-oriented cast polycarbonate resin, or the like.

The optical filter may be formed on the polarizer film. An LCD employing the optical filter may realize clear pictures without occurrence of a rainbow pattern.

Hereinafter, the constitution and function of embodiments will be explained in more detail with reference to the following examples. These examples are provided for illustrative purposes only and are not to be in any way construed as limiting the embodiments. A description of details apparent to those skilled in the art will be omitted herein.

### EXAMPLES

### Example 1

A 80 μm triacetyl cellulose film (TAC, Fujifilm Holdings Corp.) as a non-crystalline film was sequentially coated with an antistatic hard coating solution having a solid content of 30% (EC190-10, Kriya Materials) and a low refractive index solution having a solid content of 10% (TU2157, JSR Co.) through bar coating. For antistatic hard coating, the film was coated with the solution using a #12 bar, followed by drying and curing, thereby forming a hard coating layer having a thickness of 5 to 10 μm. Low refractive index coating was performed in the same manner as in formation of the hard coating layer except for use of a #4 bar to foam a low refractive index layer having a thickness of 100 nm, thereby forming an antireflective coating layer. Drying and curing were performed under the following conditions. Drying was conducted at 80° C. for 2 minutes, and curing was conducted by UV curing at 300 to 1,000 mJ/cm² using an 80 W/cm² high-pressure mercury lamp in a UV curing device.

Only a bezel, e.g., except for a TV screen part, on one side of the non-crystalline film where the coating layers were not formed was gravure-printed using black ink having a dispersed pigment. A transparent adhesive film (TG-6213, Sumiron Co., Ltd.) was attached to the black ink-printed side of the film, and the non-crystalline film was attached and secured to transparent glass (soda-lime glass) using the adhesive film.

### Comparative Example 1

An optical filter was manufactured in the same manner as in Example 1 except that a 100 μm PET film (Toyobo Co. Ltd.) was used instead of the non-crystalline film.

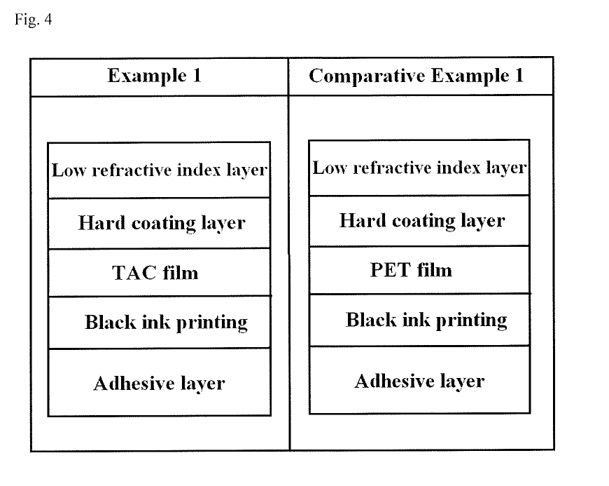

The stacked structures according to Example 1 and Comparative Example 1 are illustrated in FIG. 4. The prepared optical filters were evaluated as to transmittance, reflectivity, and rainbow properties.

Transmittance (%)

Total light transmittance was measured using a haze meter.

Reflectivity (%)

A back side of each manufactured film was sanded and coated with matte black paint, followed by measurement of reflectivity using a UV-Vis spectrophotometer (Perkin Elmer), thereby obtaining a minimum reflectivity.

Rainbow Pattern

The specimen attached to the glass substrate was placed in front of an LCD screen at a distance of 10 mm and observed with the naked eye to measure the extent of a rainbow phenomenon. The extent of a rainbow phenomenon was divided into 5 levels, from Level 1 (Appropriate) to Level 5 (Defective).

* Level of rainbow phenomenon

Level 1: No rainbow pattern.

Level 2: Rainbow pattern recognized within 50 cm.

Level 3: Rainbow pattern remarkably recognized within 50 cm.

Level 4: Rainbow pattern recognized from 1 m or more.

Level 5: Rainbow pattern remarkably recognized from 1 m or more.

TABLE 1

| | Transmittance | Reflectivity | Rainbow pattern |
|---|---|---|---|
| Example 1 | 93.9% | 0.93% | 1 |
| Comparative | 94.6% | 0.95% | 4 |
| Example 1 | | | |

As shown in Table 1, the optical film according to Example 1 did not have a rainbow pattern, whereas the optical film according to Comparative Example 1 had a rainbow pattern recognized from a distance.

By way of summary and review, when a base film coated with functional coating layers has birefringence properties, a rainbow pattern may be formed on the screen part due to optical interference with the polarizer film of the LCD. A representative birefringence film includes a PET film, which may have a refractive index varying according to directions by arrangement of high molecular weight molecules in a stretched direction when the film is stretched in a length or width direction.

A TAC film used as a polarizer film may allow light to travel in straight lines, i.e., it may not have birefringence properties, and thus it may be employed for an LCD film using polarization properties of light. When light passing through the polarizer film meets a substrate having birefringence properties, the speed of light may change depending on directions, thereby visually creating a rainbow. A rainbow phenomenon may be more serious in a large LCD TV. In particular, the rainbow phenomenon may deteriorate product quality of a 3D LCD TV, thereby making it difficult for the 3D LCD TV to realize clear pictures.

One or more embodiments provide an optical filter which does not exhibit a rainbow phenomenon, is suited to LCDs, particularly 3D LCDs, and includes a print layer formed on a bezel to omit a frame. One or more embodiments may provide an LCD that may realize clear pictures without occurrence of a rainbow phenomenon.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An optical filter, comprising:
a non-crystalline film;
a protective coating layer on one side of the non-crystalline film; and
a print layer on another side of the non-crystalline film, the other side being opposite to the one side,
wherein the print layer is secured to a substrate.

2. The optical filter as claimed in claim 1, wherein the non-crystalline film is a transparent non-oriented film.

3. The optical filter as claimed in claim 1, wherein the non-crystalline film includes a cellulose resin, a polycarbonate resin, a (meth)acrylate resin, a cycloolefin resin, an amorphous polyester resin, or combinations thereof.

4. The optical filter as claimed in claim 1, wherein the protective coating layer includes an antireflective coating, a hard coating, or a combination thereof.

5. The optical filter as claimed in claim 4, wherein the optical filter includes a substrate, an adhesive layer, the print layer, the non-crystalline film, the hard coating, and the antireflective coating, stacked in that order.

6. The optical filter as claimed in claim 1, wherein the print layer is continuous or discontinuous.

7. The optical filter as claimed in claim 1, further comprising an adhesive between the print layer and the substrate, the adhesive securing the print layer to the substrate.

8. The optical filter as claimed in claim 1, wherein the substrate is a glass substrate or a non-oriented plastic substrate.

9. The optical filter as claimed in claim 8, wherein the substrate is the non-oriented plastic substrate, the non-oriented plastic substrate being a polymer sheet including glass fiber or a non-oriented casting-type polycarbonate resin.

10. The optical filter as claimed in claim 1, wherein the optical filter is on a polarizer film.

11. A liquid crystal display including the optical filter of claim 1.
